(19) United States
(12) Patent Application Publication
(10) Pub. No.: US 2005/0268413 A1
(43) Pub. Date: Dec. 8, 2005

(54) Shaped washing elements for vehicle wash systems

(75) Inventor: Daniel Pecora, Palatine, IL (US)

Correspondence Address: MICHAEL P. MAZZA, LLC, 686 CRESCENT BLVD., GLEN ELYN, IL, 60137, US

(73) Assignee: Erie Brush & Manufacturing Corporation

(21) Appl. No.: 10/920,956

(22) Filed: Aug. 18, 2004

Related U.S. Application Data
(63) Continuation-in-part of application No. 10/859,696, filed on Jun. 3, 2004.

(51) Int. Cl. B60S 3/04

(52) U.S. Cl. 15/97.3; 15/53.2; 15/230.16

(57) ABSTRACT

A shaped washing element used in a car wash system, having a proximal portion with a generally rectangular shape in length and width, and a shaped distal portion which is not generally rectangular-shaped in length and width. The washing element may be made of any material suitable for washing and/or polishing vehicles. Microfiber or another suitably soft material attached to a less expensive base material may be used for scratch-free cleaning leaving a shiny/gloss surface sheen. Distal portions with curved ends, or with generally V-shaped or U-shaped ends, sized to permit efficient cleaning of dips and undulations in vehicle surfaces such as the hood, side panels and rocker panels are preferred. Shaped washing elements according to the present invention are believed to provide increased cleaning efficiency, greater durability, and less propensity for damaging vehicles.

### CONTINUATION INFORMATION

This application is a continuation-in-part of the identically-titled and commonly-assigned patent application filed Jun. 3, 2004, U.S. Ser. No. 10/859,696, as to which priority is hereby claimed as to common subject matter.

### BACKGROUND OF THE INVENTION

The present invention relates to the field of washing apparatus and machines for vehicles such as cars, trucks, buses, trains, recovery vehicles, etc. More specifically, the invention is directed to designs for washing and/or polishing of vehicles using curtains and/or brushes typically employed in vehicle wash systems.

Generally, automatic vehicle washing systems include various mechanisms to wash vehicles, including hanging curtains, also referred to as mitters or hangdowns, among other names, that are suspended vertically in the vehicle conveyor line, tunnel, roll-over, wash bay, or polish bay (“vehicle wash system”) (e.g., FIG. 1) and/or brushes that extend radially from rotating machines which may have vertical (e.g., FIG. 2) or horizontal axes. Mechanisms are typically employed to move the curtains or brushes, causing them to oscillate or rotate or the like so that they contact as many portions of the vehicle as possible as it passes through the vehicle wash system, or a wash machine passes over the vehicle (depending upon the system employed). Vehicle wash systems also may employ rotating machines with brushes, cloths, etc., extending radially outward from the machines to wash the sides and/or top and rear of vehicles.

Prior art patents describe, for example, curtains consisting of fabric panels cut into multiple strips and suspended vertically from an overhead support structure. Some prior patents reference curtains with variable lengths to prevent entanglement with successive rows. Still other prior patents disclose the use of pie-shaped washing elements (for rotating brushes), or rectangular washing elements (for hang-down curtains) with slits at the bottom to provide independent contact surfaces; for example, the pie-shaped cloth elements may be oriented in circular arrays for rotating brushes, as disclosed in U.S. Pat. No. 6,035,482, which is incorporated by reference in its entirety into this application.

Prior art vehicle wash systems have encountered difficulty in thoroughly cleaning vehicle surfaces without grabbing or catching on vehicle parts such as rear wipers, or without thoroughly cleaning hood or side panels with dips and undulations, or lower car rocker panels, which are typically convex-shaped with trim attached.

Despite advances in vehicle wash systems and apparatus, there is still a need for providing a vehicle wash system with improved cleaning capabilities and enhanced durability which also minimizes possible damage to the vehicle being washed.

### SUMMARY OF THE INVENTION

The present invention overcomes disadvantages of prior car wash systems and apparatus, while providing new advantages not previously obtainable.

In one embodiment of the present invention, a shaped washing element for use in a vehicle wash system is provided. The washing element includes a proximal portion having a length and width forming a generally rectangular shape. The washing element also includes a shaped distal portion which is not generally rectangular-shaped in length and width, for contacting the surface of a vehicle to be washed. The washing element may include any material suitable for washing and/or polishing vehicles, including but not limited to (or combinations thereof): cloth; shallow pile synthetic lambs' wool; deep pile synthetic lambs' wool; a felt or synthetic felt material; or a closed cell foam material. The washing elements may hang vertically down to form one or more downwardly extending curtains having a width varying from about 2-150 inches. Alternatively, the washing elements may be oriented generally perpendicular to, and extend radially outward from, an axis of a rotating cleaning apparatus; this axis may extend either generally vertically, generally horizontally, or at any other angle from the ground.

In a preferred embodiment, shaped distal portions of adjacent washing elements may be provided, either on hang-down curtains or on rotating brushes, for example. These shaped distal portions may include shaped flaps and/or curtains, which may form shapes which are sinusoidal, generally V-shaped, generally U-shaped, or other cross-sectional shapes provided they are non-rectangular. These flaps or slats may but need not have distal ends consisting of divided, shaped washing fingers, which are generally used for rotating brushes. If used for rotating brushes, such fingers are preferably about 3-30 inches in length, and preferably about ⅜-1 inch in width. The shaped distal portions may be generally hemispherical (e.g., with a radius of 3/16 to ½ inches for rotating brushes and 1-4 inches for hang-down curtains), generally V-shaped, generally curvilinear, or form other non-rectangular shapes. Depending upon the car wash machine/mechanism used and its orientation, the shaped distal portions of the washing elements of hang-down curtains may first contact the vehicles facewise (i.e., the width of the distal portion is oriented to face the surface of the vehicle to be contacted), edgewise, or at some angle in between.

In a particularly preferred embodiment, a shaped washing element for use in a vehicle wash system includes a proximal portion and a shaped distal portion which is not generally rectangular-shaped in length and width, for contacting the surface of a vehicle to be washed. The distal portion preferably has an included angle sized to facilitate cleaning by the distal portion of dips and undulations on the vehicle surface, such as the hood, side panels with or without trim, and rocker panels.

In preferred embodiments of a distal portion for a hang-down curtain, and referring now to FIG. 3 (far right drawing), given a slat width “c,” a shaped curtain length “b” and an included angle “A,” these parameters may have the following approximate dimensions in various embodiments, for example. For c=3 inches: b=6 inches, A=28°; b=8 inches, A=22°; b=10 inches, A=17°; b=12 inches, A=14°; and b=14 inches, A=12°. For c=6 inches: b=12 inches, A=28°; b=18 inches, A=19°; b=26 inches, A=13°; and b=30 inches, A=11°. Similar distal portions for contacting vehicle surfaces may also be used with rotating brushes.

In another preferred embodiment, the distal portion may be made of an extremely soft material such as microfiber or another suitable material, which may be attached to a less expensive material such as a base material. Suitable base materials include but are not limited to cloth; ozite; felt; or synthetic felt.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIGS. 1 and 2 are perspective views of a prior art curtain, and vertically oriented rotating equipment utilizing rotating brushes, respectively, used in conventional vehicle wash systems;

FIG. 3 is a schematic view of portions of a curtain having alternative, shaped distal ends according to one preferred embodiment of the present invention;

FIG. 4 is a schematic view similar to FIG. 3 showing a curtain according to various embodiments of the present invention with exemplary, differently-sized flaps having hemispherically-shaped distal ends;

FIG. 5 is a perspective view showing a rotating brush with a vertical axis, with each separate clump, piece or element of the rotating brush having shaped ends;

FIGS. 6 and 7 are perspective views of one embodiment of the car wash system of the present invention using static, shaped, hang-down curtains including front-to-back and side-to-side mitters, respectively, for washing vehicles moving on a conveyor;

FIG. 8 is an enlarged view of the circled portions of FIGS. 6 and 7 illustrating the shaped distal ends of the curtains;

FIG. 9 is a perspective view of a Mercedes Benz which is an exemplary vehicle for present illustration;

FIGS. 10 and 11 are partial front views of the vehicle shown in FIG. 9;

FIG. 12 is a partial planar, side and front perspective view of the vehicle portion shown in FIGS. 10 and 11, with the vehicle hood being washed by shaped hang-down curtains according to the present invention.

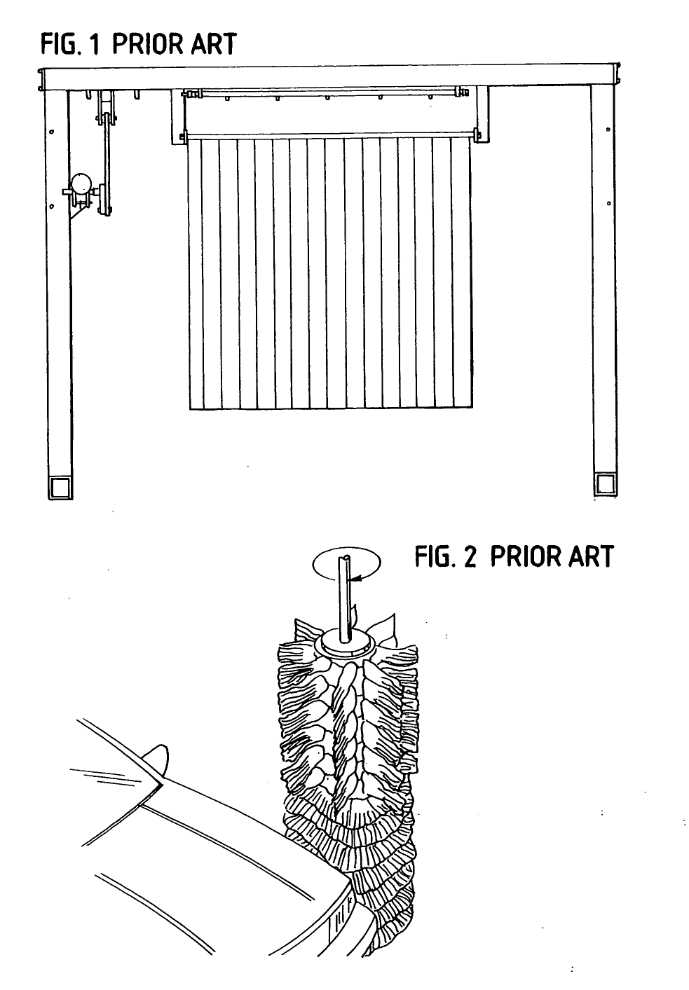

### DEFINITION OF CLAIM TERMS

The terms used in the claims of the patent as filed are intended to have their broadest meaning consistent with the requirements of law.

“Curtain” means a washing element, which may be divided into slats or flaps.

“Fingers” mean smaller, distal portions of a washing element that may form divided portions of a larger washing element.

“Shaped” refers to the shape of the distal portion of a washing element, which may be generally sinusoidal, generally V-shaped, generally U-shaped or other shapes provided they are non-rectangular.

“Washing element” means material designed to contact a vehicle to be washed, including but not limited to rotating brushes, hang-down curtains, etc.

Where alternative meanings are possible, the broadest meaning is intended. All words used in the claims are intended to be used in the normal, customary usage of grammar and the English language.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

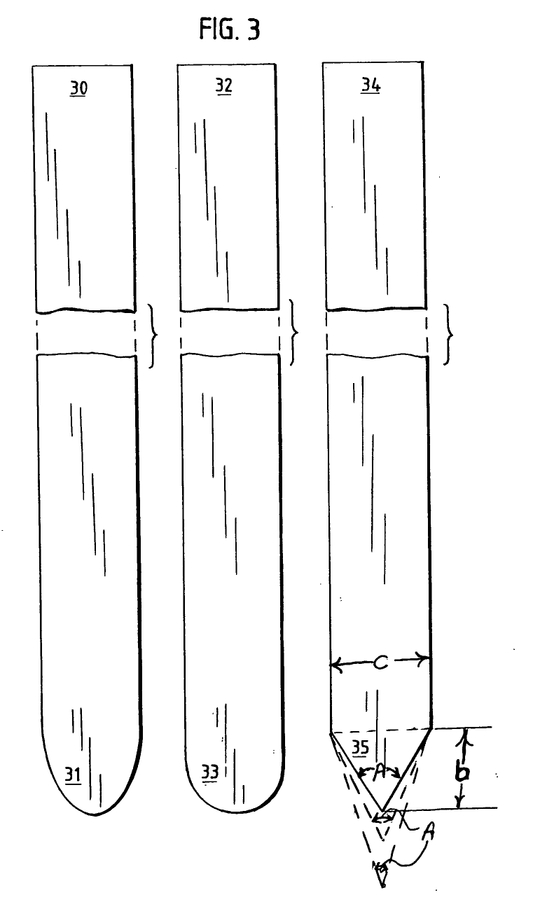

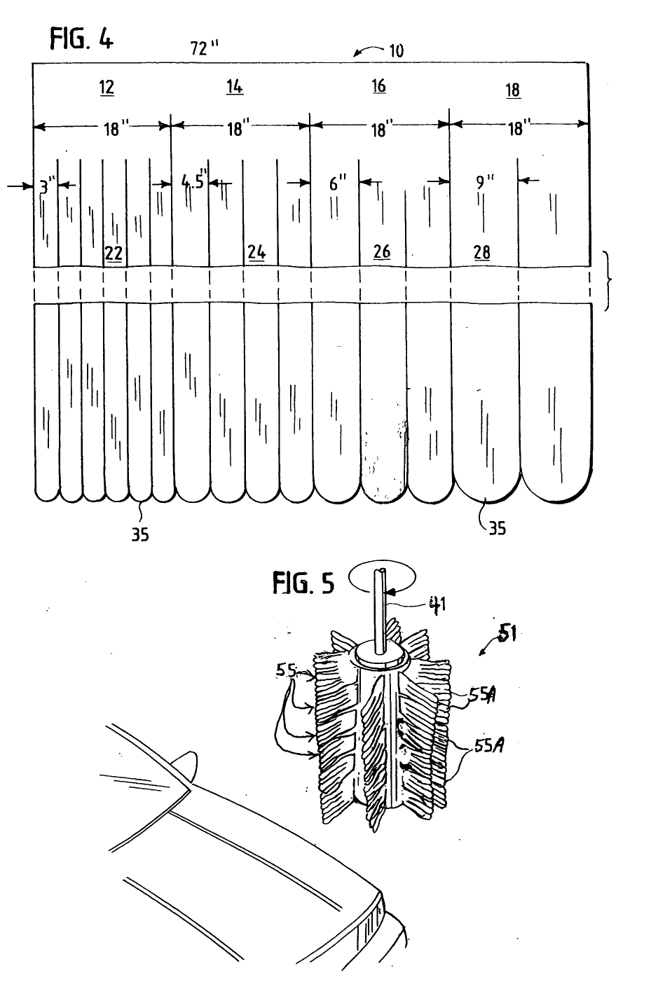

In accordance with a preferred embodiment of this invention, a washing element, which can be attached to or part of a vertically suspended curtain, or may consist of a brush element extending radially from a rotating machine, is designated with the reference numeral 10 in FIG. 4, and with the reference numeral 51 in FIG. 5. In alternative embodiments, the curtain or brush which is washing element 10 or 51 can have various dimensions. Referring to FIGS. 3-4, a curtain 10 may have a slat or flap 30, 32, 34 having a width from about 2-3 inches up to about 100 inches (cars) or 150 inches (oversize for, e.g., trains, trucks or buses) depending on the vehicle to be washed and the structure of the vehicle wash system. Referring to FIG. 5, each brush element 55A within a rotating brush array 55 may have a length extending from the core axis of anywhere from about 3 inches to about 34 inches. These widths and/or lengths are dependent upon the equipment, and on whether the curtain or brush is intended to wash cars, buses, trucks, trains, etc, and which parts of the vehicle it will be washing or polishing.

Referring to FIG. 5, the rotating speed of each brush 55, as well as the selected length and width of the washing fingers, affects washing performance. Theoretically, narrower fingers provide higher cleaning efficiency. However, wider fingers tend to be more durable and withstand more wear and tear with less ripping or tearing of the washing and/or polishing material.

FIG. 4 shows an embodiment in which curtain 10 is 72 inches wide. To show the wide range of combinations available with this invention, FIG. 4 shows curtain 10 divided into sections 12, 14, 16, or 18 which can themselves be subdivided into flaps of different sizes 22, 24, 26, or 28 for more cleaning choice. In one embodiment, section 12 of curtain 10 is subdivided into flaps 22. For example, as shown in FIG. 4, section 12 of curtain 10 is 18 inches wide with each of the six flaps having a width of 3 inches.

In an alternative embodiment, section 14 of curtain 10 is subdivided into four flaps 24. In FIG. 4, for example, section 14 of curtain 10 may again be 18 inches wide with each of the four flaps having a width of 4.5 inches. In this embodiment, the curtain 10 follows the pattern of section 14 where each individual slat 24 is 4.5 inches wide. Similarly, section 16 of curtain 10 may include three flaps 26 each with a width of 6 inches, while section 18 of curtain may include two flaps 28 each with a width of 9 inches. FIG. 4 is provided only to illustrate different slat dimensions of shaped curtains that may be provided, not to indicate that a curtain should be manufactured which has such different slat dimensions.

As another example, FIG. 5 shows a rotating brush 51 with a vertical axis 41. Each separate array 55 of the rotating brush may include a shaped distal end (i.e., an end that is non-rectangular in shape) having divided fingers 55A, for example. (Shaped ends 55A of FIG. 5 contrast with the ends of the rotating brush shown in prior art FIG. 2 which have ends which are rectangular-shaped.)

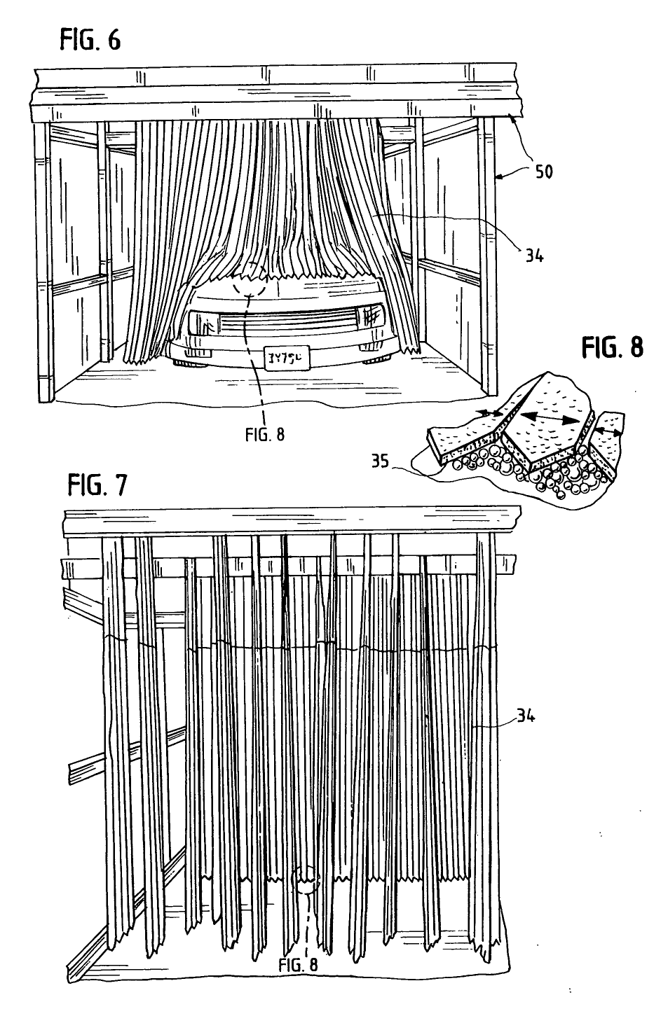

Referring now to FIGS. 6-8, one embodiment of the car wash system of the present invention using hang-down curtains having shaped distal ends is shown. Frame 50 supports shaped curtains 34 having shaped distal ends 35.

The preceding examples provide specific values for curtain or brush width, as well as specific values for finger or slit width and number. These examples, however, are not meant in any way to limit this invention to the specific values described in the examples; rather, they are meant to provide an idea of the wide range of combinations of curtain and shaped slat and/or shaped slat/finger combinations this invention envisions. This invention contemplates size variations for any shaped washing element which may be employed in a vehicle washing system. These shaped washing elements may have many fingers or no fingers, and may utilize as many separate distal portions as are necessary to efficiently clean and protect the vehicle. The width of each finger may but need not be equal; for example, wider and thus less grabby fingers may be used for those fingers that contact antennas, wipers and mirrors, for example.

In accordance with each of the embodiments described above, the shaped distal ends of the slats of curtain 10 (FIG. 4) or of brush 51 (FIG. 5) may include the additional feature of a non-rectangular bottom or distal portion. In FIG. 3, each flap 30, 32 and 34 represents a part of curtain 10, and includes a distal portion 31, 33, 35 which is a shaped washing element. These flaps may have the dimensions specifically described for the examples above, or other dimensions such as the ranges described more generally above. The shaped distal ends are preferably reshaped over time if the ends rip, tear or wear at their contours through use.

It is understood that the shaped distal portions of curtain 10 are not the only portions of the curtain to contact a vehicle during washing. However, the shaped distal portions are believed to provide a substantial washing and/or polishing and protecting function. In addition, the rectangular distal portions are sometimes thought to be responsible for past problems when the curtains wear or tear, and then grab and/or become entangled with vehicle parts. These distal portions are also the portions of the curtain that tend to wear first, prior to other parts of the curtain.

Flaps 30, 32 in FIG. 3 have curvilinear-shaped distal portions 31, 33, respectively. FIG. 3 shows flap 34 with distal portion 35 in a V-shaped configuration. Vehicle washing elements may catch or grab vehicle parts such as side view mirrors, antennae, and front and rear wipers. It was discovered that washing elements with non-planar distal portions, such as V-shaped, generally V-shaped, curvilinear such as semicircular, or other non-rectangular shapes, surprisingly provide less propensity to grab or catch on vehicles and vehicle parts during the washing process. Thus, washing elements having shaped distal portions decrease the possible risk of damage to vehicle components during washing, allowing the car wash owner to get closer to achieving zero car damage. It is also believed that washing elements with shaped distal portions increase cleaning efficiency by reaching into grooves, dips, crevices or surface undulations in the vehicle body, and other areas on the vehicle that were sometimes not thoroughly cleaned using prior systems.

In one preferred embodiment shown in FIG. 3, shaped distal portion or element 33 forms a semicircular shape having a radius that is preferably in the range of less than or equal to about 1-3 inches. Shaped distal portions 31 and 35, while consisting of different shapes, may have generally similar dimensions.

Washing elements 10 of this invention may be suitable for wet washing cars and other vehicles, as in typical car wash apparatus. Washing elements 10 may also be suitable for wet washing and wet or dry polishing of cars and other vehicles.

Washing element 10 may be made of various materials, such as but not limited to the following: shallow pile synthetic lambs' wool; deep pile synthetic lambs' wool; cloth, felt, synthetic felt, foam such as closed cell foam; or any other material suitable for washing or polishing vehicles. Use of deep pile synthetic lambs' wool material and other appropriate materials are described, for example, in U.S. Pat. Nos. 5,077,859 and 5,134,742 to Ennis.

The washing element portions which contact the vehicle may, in a particularly preferred embodiment, be made of microfiber or another very soft, non-abrasive material to avoid scratching a painted or clear-coat vehicle surface.

Of course, with side-to-side or front-to-back mitters, for example, the microfiber or other suitable soft material should be present on each side of the mitter, since each side contacts the vehicle. One suitable microfiber material is available, for example, from Clean-Pro Industries, Inc. of Portland, Oreg., or Business Solutions Unlimited Inc. of Delray Beach, Fla. As the limp microfiber material (a man-made material which combines polyester and polyamide fibers, having a thickness, for example, on the order of approximately 1/100 of a human hair) may not hold up by itself without a base material, the microfiber may be connected by adhesives, Velcro® and/or hook-and-loop, sewing or other attachment means to a less expensive backing material such as cloth, ozite, or other materials. If used on an oscillating machine, it may be useful to provide microber or a suitably soft material on both sides of the base material. If used on a static machine, the microfiber or suitably soft material may just be attached to one side of the base material This would ensure that the only material which touches the vehicle surface is the microfiber or other suitably soft material, to avoid scratches, marks or haze, and to preserve a shiny/glossy vehicle surface finish.

It was also discovered that the smaller the included angle “A” (see FIG. 3, far right drawing), the better the cleaning of various vehicle surface, such as but not limited to: hoods, windshields, and rear windows, including dips and undulations in the hood as well as side panels and lower car rocker panels. Smaller included angles “A” generally allow better entry and cleaning of such dips and undulations, and above and below vehicle trim. As representative examples, referring now to FIG. 3 (far right drawing), given a slat width “c,” a shaped curtain length “b” and an included angle “A,” these parameters may have the following approximate dimensions in various embodiments, for example. For c=3 inches: b=6 inches, A=28°; b=8 inches, A=21°; b=10 inches, A=17°; b=12 inches, A=14°; and b=14 inches, A=12°. For c=6 inches: b=12 inches, A=28°; b=18 inches, A=19°; b=26 inches, A=13°; and b=30 inches, A=11°. As the slat length decreases and the included angle increases, it is believed that some cleaning efficiency is lost. In addition to hang-down curtains, this aspect of the present invention may be used for rotating brushes.

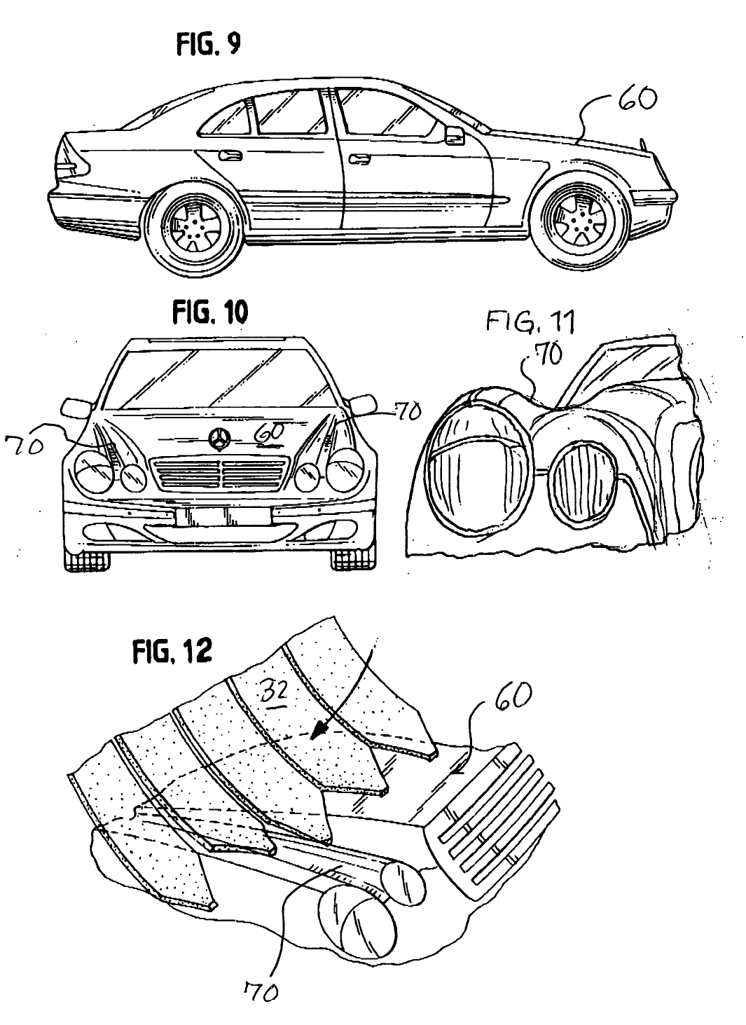

Dips and undulations 70 for the hoods 60 of certain vehicles such as the Mercedes Benz shown in FIGS. 9-12 may be of such a size (e.g., about 1-5 inches in width) that cleaning may be improved if the distal portion of the brush/curtain is less than the dip width. For this purpose, the shaped ends of the hang-down curtains shown in FIG. 12, for example, find particular utility.

Other changes and modifications constituting insubstantial differences from the present invention, such as those expressed here or others left unexpressed but apparent to those of ordinary skill in the art, can be made without departing from the spirit and scope of the present invention and without diminishing its attendant advantages. It is, therefore, intended that such changes and modifications be covered by the following claims.

1. A shaped washing element for use in a vehicle wash system, comprising:
a proximal portion;
a shaped distal portion which is not generally rectangular-shaped in length and width, for contacting the surface of a vehicle to be washed, the distal portion being sized to facilitate cleaning of dips and undulations on the vehicle surfaces;
wherein the washing element comprises any material suitable for washing and/or polishing a vehicle.

2. The shaped washing element of claim 1, wherein the distal portion comprises a radius portion.

3. The shaped washing element of claim 1, wherein the distal portion comprises two generally planar sides and an included angle.

4. The shaped washing element of claim 3, wherein the included angle is less than or equal to about 28°.

5. The shaped washing element of claim 3, wherein the included angle is in the range of between about 11°-28°.

6. The shaped washing element of claim 5, wherein the included angle is in the range of between about 11°-22°.

7. The shaped washing element of claim 5, wherein a width of the proximal portion is between about 3-6 inches.

8. The shaped washing element of claim 6, wherein a length of the shaped distal portion is between about 6-30 inches.

9. The shaped washing element of claim 1, wherein the shaped washing element forms, with a plurality of other similar washing elements, one or more hang-down curtains.

10. The shaped washing element of claim 1, wherein the shaped washing element forms, with a plurality of other similar washing elements, one or more rotating brushes.

11. A shaped washing element for use in a vehicle wash system, comprising:
a proximal portion;
a shaped distal portion which is not generally rectangular-shaped in length and width, for contacting the surface of a vehicle to be washed, the distal portion comprising a suitable material for contacting and cleaning the vehicle surface in a scratch-free manner.

12. The shaped washing element of claim 11, wherein the suitable material comprises microfiber.

13. The shaped washing element of claim 11, wherein the suitable material comprises one or more of the following: deep or shallow pile synthetic lambs' wool.

14. The shaped washing element of claim 11, wherein the suitable material is attached to the proximal portion, and wherein the proximal portion comprises a base material.

15. The shaped washing element of claim 14, wherein the base material is selected from one or more of the following: cloth; ozite; felt; or synthetic felt.

16. The shaped washing element of claim 11, wherein the distal portion is sufficiently sized to facilitate cleaning by the distal portion of dips and undulations on vehicle surfaces.

17. The shaped washing element of claim 16, wherein the distal portion includes a curved end.

18. The shaped washing element of claim 16, wherein the distal portion includes two generally planar edges and an included angle less than or equal to about 28°.
